(19) United States
(12) Patent Application Publication
(10) Pub. No.: US 2009/0300572 A1
(43) Pub. Date: Dec. 3, 2009

(54) Method of Correcting Etch and Lithographic Processes

(76) Inventors: Martin Keck, Muenchen (DE); Joerg Thiele, Vaterstetten (DE); Robert Wildfeuer, Dresden (DE); Christof Bodendorf, Muenchen (DE)

Correspondence Address: SLATER & MATSIL, L.L.P., 17950 PRESTON ROAD, SUITE 1000, DALLAS, TX, 75252, US

(21) Appl. No.: 12/130,741

(22) Filed: May 30, 2008

(51) Int. Cl. G06F 17/50

(52) U.S. Cl. 716/19

(57) ABSTRACT

System and method of correcting etch and lithographic processes on a photo mask provides for performing an etch proximity correction on a layout design pattern. A first and a second intermediate layout pattern each being based on the etch proximity corrected layout design pattern are provided. An optical proximity correction on the first intermediate layout pattern is performed so as to generate a modified first intermediate layout pattern. Scatterbar generation on the second intermediate layout pattern is performed so as to generate a modified second intermediate layout pattern including scatterbars. Generating a mask layout pattern being based on the first and the second modified intermediate layout pattern is performed.

### TECHNICAL FIELD

Embodiments of the invention relate to methods of correcting etch and lithographic processes on a photo mask, a system of correcting etch and lithographic processes on a photo mask and a computer readable medium.

### BACKGROUND

Currently, there are several concepts known in the art which address the problem of increasing the resolution capabilities during lithographic processes. According to a first example, off-axis illumination in the projection system of the projection apparatus together with sub-resolution sized assist features is used. In a second example, the concept of alternating phase shift masks is employed so as to enhance the resolution capabilities of the projection apparatus.

In order to achieve dimensional accuracy of the mask pattern during imaging on a substrate and/or improve the manufacturing process window, sub resolution sized assist features or structures for optical proximity correction can be included in the mask pattern. These features are additional structures as, e.g., serifs or hammerheads, or are placed in close proximity to the original mask features. Size, shape and placement of these structures are usually determined by using a simulation model of the photolithographic projection. Such a simulation model is usually called an OPC model or model for optical proximity correction.

Besides optical proximity correction, transfer processes like an etch process also affect the pattern fidelity during manufacturing of integrated circuits. Influences of pattern transfer are usually referred to as etch proximity effects. Etch proximity effects are usually accounted for by an etch process compensation model which can be part of a computer aided design system.

Usually, both a model for optical proximity correction and a model for etch process compensation are applied to the layout pattern. Accordingly, there is a need in the art to provide improvements during etch and optical proximity correction before manufacturing of an integrated circuit.

### SUMMARY OF THE INVENTION

The method of correcting etch and lithographic processes on a photo mask provides for performing an etch proximity correction on a layout design pattern. A first and a second intermediate layout pattern each being based on the etch proximity corrected layout design pattern are provided. An optical proximity correction on the first intermediate layout pattern is performed so as to generate a modified first intermediate layout pattern. Scatterbar generation on the second intermediate layout pattern is performed so as to generate a modified second intermediate layout pattern including scatterbars. Generating a mask layout pattern being based on the first and the second modified intermediate layout pattern is performed.

The system of correcting etch and lithographic processes on a photo mask provides for an input interface being capable of receiving a layout design pattern. The system further includes a processing unit. The processing unit is capable of storing the layout design pattern, performing an etch proximity correction on the layout design pattern, providing a first and a second intermediate layout pattern each being based on the etch proximity corrected layout design pattern, performing an optical proximity correction on the first intermediate layout pattern so as to generate a modified first intermediate layout pattern. In addition, the processing unit is capable of performing scatterbar generation on the second intermediate layout pattern so as to generate a modified second intermediate layout pattern including scatterbars, and generating a mask layout pattern being based on the first and the second modified intermediate layout pattern. The system further includes an output interface. The output interface is capable of transmitting the mask layout pattern to a mask writer.

### BRIEF DESCRIPTION OF THE DRAWINGS

In the accompanying drawings:

FIG. 1 schematically illustrates a layout pattern in a top view;

FIG. 2 schematically illustrates a layout pattern in a top view;

FIG. 3 schematically illustrates a layout pattern in a top view;

FIG. 4 schematically illustrates a layout pattern in a top view;

FIG. 5 schematically illustrates a layout pattern in a top view;

FIG. 6 illustrates a system in a schematic view;

FIG. 7 illustrates a flow diagram of process steps; and

FIG. 8 illustrates a flow diagram of process steps.

### DETAILED DESCRIPTION OF ILLUSTRATIVE EMBODIMENTS

Embodiments of methods and systems of correcting etch and lithographic processes on a photo mask are discussed in detail below. It is appreciated, however, that the present invention provides many applicable inventive concepts that can be embodied in a wide variety of specific contexts. The specific embodiments discussed are merely illustrative of specific ways and do not limit the scope of the invention.

In the following, embodiments and/or implementations of the method and the system are described with respect to improving resolution capabilities during lithographic projection of a layer of an integrated circuit. The embodiments, however, might also be useful in other respects, e.g., improvements in process capabilities, improvements in printing parts of a layout of a pattern together with further patterning steps, yield enhancement techniques or the like.

Furthermore, it should be noted that the embodiments and/or implementations are described with respect to dense line-space-patterns but might also be useful in other respects including but not limited to dense patterns, semi dense patterns or patterns with isolated lines, as well as for contacts, islands and combinations between all them. The embodiments and/or implementations can also be employed on a single layer, a part of a single layer or on several layers. Lithographic projection can also be applied during manufacturing of different products, e.g., semiconductor circuits, thin film elements. Other products, e.g., liquid crystal panels or the like might be produced as well.

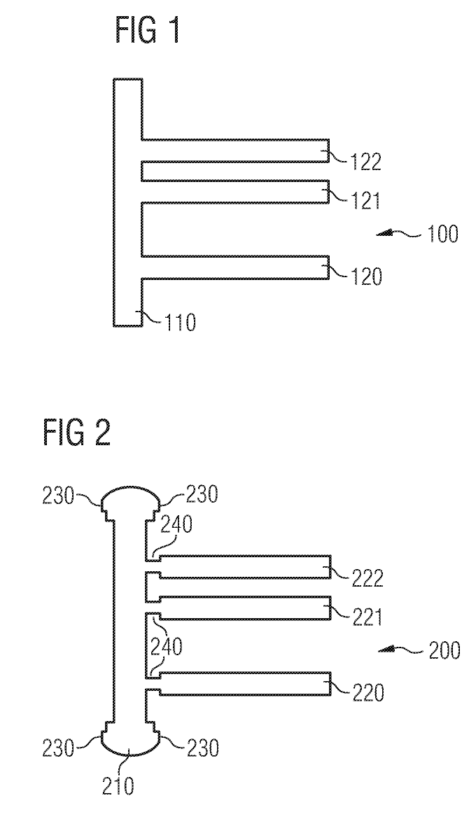

Making reference now to FIG. 1, a first embodiment is described. In FIG. 1, a layout pattern 100 is shown. The layout pattern 100 can be generated by any commercial available computer aided design program, e.g., provided by CADENCE Design Systems or Mentor Graphics, and stored in a data representation suitable for further processing, e.g., GDSII or the like. The invention, however, is neither restricted to a specific CAD tool nor to a certain data format.

As shown in FIG. 1, the layout pattern 100 includes a first pattern segment 110 being arranged vertically, and three further pattern segments 120-122 being arranged horizontally. The two uppermost pattern segments 121 and 122 are spaced close to each other as a pair of minimal sized lines being arranged at a minimal distance, while the pattern segment 120 is arranged as a semi-isolated line.

In a first step, the layout pattern 100 is subjected to an etch process compensation. Etch process compensation is applied on the layout pattern 100 in order to compensate for different lateral etch rates according to the surrounding pattern of a certain pattern segment. As already outlined above, etch rates depend on the pattern proximity and would cause an additional pattern distortion if not compensated already during mask production. Accordingly, the original layout pattern is modified such that after an etching step, different lateral etch rates are accounted for by altering structural dimensions of the layout pattern.

Making reference now to FIG. 2, an etch process compensated layout pattern 200 is shown which can be generated by a commercially available simulation tool, by geometrical rules derived from simulation or by experience. It should be noted that the etch process compensated layout pattern 200 of FIG. 2 merely serves as an illustration by exaggerating the applied compensation effects. In particular, the modification applied to the layout pattern might be different in a true simulation.

The etch process compensated layout pattern 200 includes a first pattern segment 210 being arranged vertically, and three further pattern segments 220-222 being arranged horizontally. The pattern segments 210, 220-222 of the etch process compensated layout pattern 200 correspond to the respective pattern segments 110, 120-122 of the original layout pattern 100. In addition, several additional segments or fragments 230 and/or cut-outs or recesses 240 can be present, as schematically indicated in FIG. 2. The degree of segmentation is chosen such that the difference between layout pattern 100 and etch process compensated layout pattern 200 is below a set of tolerances, which can be set by the user, for example.

It should be noted that the additional segments or fragments 230 and the additional recesses 240 introduced by the etch process compensation procedure can result in structural dimensions being smaller than a production grid which can be accomplished for by a mask writer for producing the photo mask. In order to account for different compensation steps, the etch process compensated layout pattern 200 is calculated using a grid being smaller than the production grid or even without applying any grid at all.

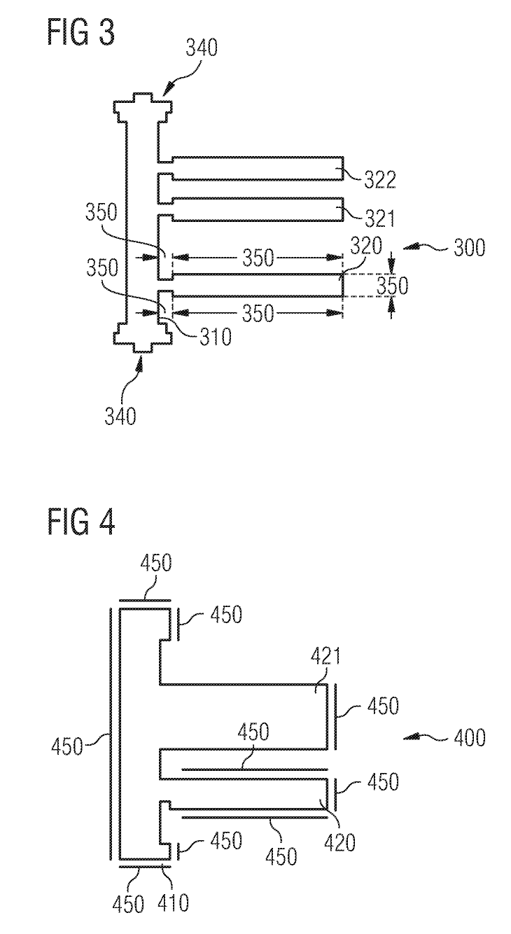

The etch process compensated layout pattern 200 is further used as a starting point for generating a first intermediate layout pattern 300 and a second intermediate layout pattern 400. This is now described in more detail referring to FIGS. 3 and 4.

In FIG. 3, the first intermediate layout pattern 300 is shown. The first intermediate layout pattern 300 is generated from the etch process compensated layout pattern 200 by applying a fine structured grid which afterwards facilitates lithographic compensation techniques. Furthermore, the first intermediate layout pattern 300 is decomposed into different short segments, which are subject to a modification procedure for optical proximity correction.

As shown in FIG. 3, first intermediate layout pattern 300 includes a first pattern segment 310 being arranged vertically, and three further pattern segments 320-322 being arranged horizontally. The pattern segments 310, 320-322 of the first intermediate layout pattern correspond to the respective pattern segments 210, 220-222 of the etch process compensated layout pattern.

Aligning to the grid includes moving additional segments 340 onto the grid, as schematically indicated with respect to the upper and lower part of pattern segment 3 10. The segmentation of the first intermediate layout pattern 300 is schematically indicated by segmentation lines 350 for pattern segment 320.

In addition, the etch process compensated layout pattern 200 is used as a starting point for the second intermediate layout pattern 400, which is now described in more detail referring to FIG. 4.

In FIG. 4, the second intermediate layout pattern 400 is shown. The second intermediate layout pattern 400 is generated from the etch process compensated layout pattern 200 by aligning the pattern segments of the second intermediate layout pattern 400 to the production grid, for example.

As shown in FIG. 4, the second intermediate layout pattern 400 includes a first pattern segment 410 being arranged vertically, and two further pattern segments 420-421 being arranged horizontally. The pattern segments 410, 420-421 of the second intermediate layout pattern correspond to the respective pattern segments 210, 220-222 of the etch process compensated layout pattern 200.

As the production grid can be coarser than a grid used during calculation of the etch process compensation, aligning to the grid can result in a coarser structure of the pattern segments of the second intermediate layout pattern 400. In addition it is also conceivable to apply pattern smoothening so as to reduce gaps or recesses within the second intermediate layout pattern.

The pattern smoothening is schematically indicated in FIG. 4 with respect to the pattern segments 410, 420-421 of the second intermediate layout pattern 400. The smoothening procedure results in a combined pattern segment 421 which correspond to respective pattern segments 221 and 222 of the etch process compensated layout pattern 200.

Processing continues by performing a scatterbar generating process on the second intermediate layout pattern 400. As shown in FIG. 4, scatterbars 450, which are composed of sub-lithographic line segments, are arranged next to the pattern segments 410, 420-421 of the second intermediate layout pattern 400.

Performing scatterbar generation on the second intermediate layout pattern usually results in an increased process window during a lithographic projection using a photo mask being based upon the second intermediate layout pattern 400. Procedures for calculating scatterbars 450 are known to a person skilled in the art and are usually part of the CAD system described above. It should be noted that a particular scattering bar algorithm can be employed as well.

It should be noted that scatterbar generation is performed taking into account the etch process compensated layout which served as a starting point for the second intermediate layout pattern 400. As pattern smoothening can be applied, the resulting scatterbars 450 can be drawn as straight lines without too many discontinuations, so as to optimize their optical behavior and mask manufacturability. In addition, the second intermediate layout pattern 400 can be aligned to the production grid which results in a mask pattern which observes design rules of the mask production process.

Processing continues by performing a lithographic compensation process on the first intermediate layout pattern and the second modified intermediate layout pattern so as to generate a compensated mask pattern. This is schematically indicated in FIG. 5 where both the first intermediate layout pattern 300 and the second intermediate layout pattern 400 including the scatterbars 450 are merged. By using a finer grid during the compensation process employed for the first intermediate layer, a higher accuracy is achieved as compared to a coarser grid. In addition, the coarser grid of second intermediate layer results in a lower data volume and less segmented scatterbars during scatterbar generation.

Lithographic compensation process includes applying line width changes, hammerheads or serifs which account for optical proximity effects, line-end shortening and the like. This technique is usually referred to as optical proximity correction, for which rule or model based algorithms can be performed, as known to the skilled person. Procedures for performing a lithographic compensation process are usually part of the CAD system.

The resulting mask pattern is shown in FIG. 5. As shown in FIG. 5, mask pattern 500 includes a first pattern segment 510 being arranged vertically, and three further pattern segments 520-522 being arranged horizontally. The pattern segments 510, 520-522 of the mask pattern correspond to the respective pattern segments 310, 320-322 of the first intermediate layout pattern 300.

In addition, scatterbars 550 are arranged next to pattern segments 510, 520-522 of the mask pattern which correspond to scatterbars 450 of the second intermediate layout pattern 400. Furthermore, several segments calculated for optical proximity correction are included as pattern segments 560. As mentioned above, pattern segments 560 can be calculated using segmentation lines 350 as a starting point for modifying features or from the target layout. The resulting pattern of mask pattern 500 can be aligned to the grid of mask production and thus form a basis for producing a photo mask.

It should be noted that an etch compensation and a lithographic compensation are performed independently on an accurate grid representation. This allows for increased performance of the photo mask, as for example, no rounding errors caused by subsequent grid aligning can occur. Furthermore, the described method steps can be implemented within a CAD program and can be initiated with a single CAD command.

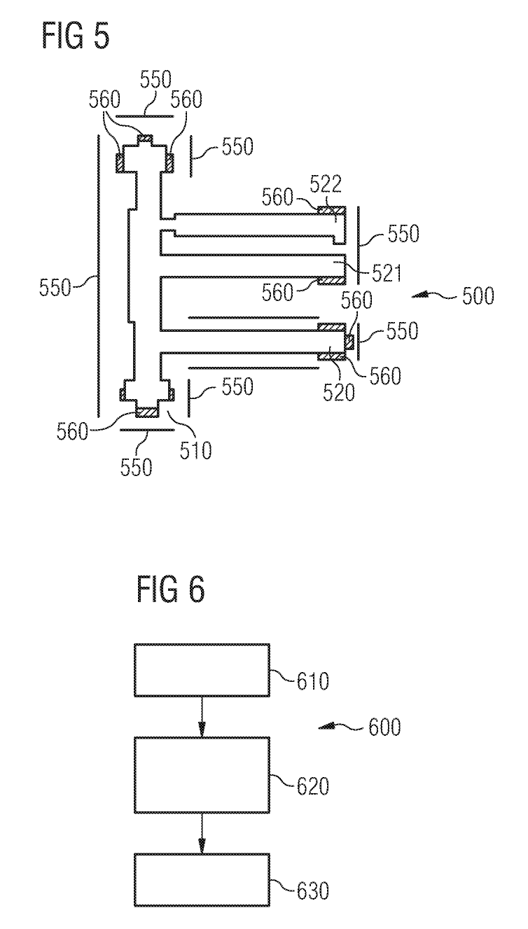

Making now reference to FIG. 6, a system 600 for correcting etch and lithographic processes for a photo mask is shown.

The system includes an input interface 610 being capable of receiving a layout design pattern, e.g., by a CAD system or the like. It should be noted that system 600 can be integral part of the CAD system as well.

The system 600 further includes a processing unit 620. The processing unit 620 is capable of storing the layout design pattern, performing an etch proximity correction on the layout design pattern, providing a first and a second intermediate layout pattern each being based on the etch proximity corrected layout design pattern, performing an optical proximity correction on the first intermediate layout pattern so as to generate a modified first intermediate layout pattern.

In addition, the processing unit 620 is capable of performing scatterbar generation on the second intermediate layout pattern so as to generate a modified second intermediate layout pattern including scatterbars, and generating a mask layout pattern being based on the first and the second modified intermediate layout pattern.

Instructions for the processing unit 620 can be stored on a computer readable medium, e.g., a CD, DVD or the like.

The system 600 further includes an output interface 630. The output interface 630 is capable of transmitting the mask layout pattern to a mask writer (not shown in FIG. 6.) or storing the mask layout on an intermediate file to be transferred to a mask manufacturer.

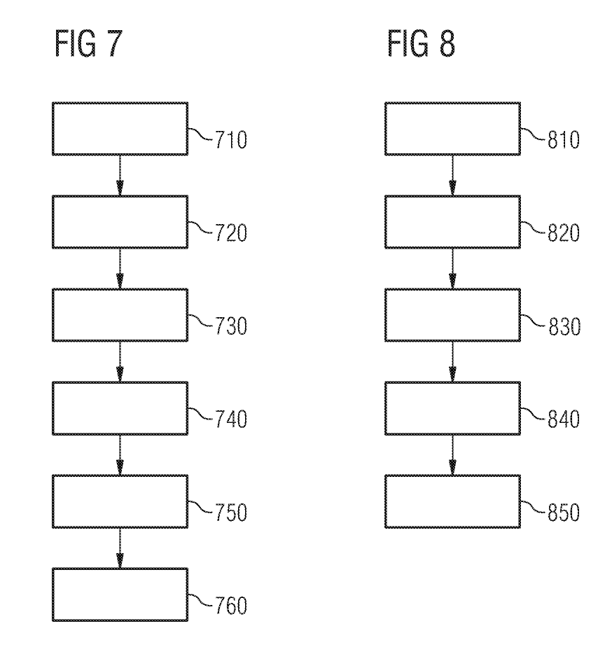

In FIG. 7, a flow diagram is shown with individual process steps capable of correcting etch and lithographic processes for a photo mask.

In step 710, a layout pattern is provided.

In step 720, an etch process compensation on the layout pattern is performed, so as to generate an etch compensated layout pattern.

In step 730, a first intermediate layout pattern from the etch compensated layout pattern is generated.

In step 740, a second intermediate layout pattern is generated from the etch compensated layout pattern.

In step 750, the second intermediate layout pattern is modified by performing a scatterbar generating process on the second intermediate layout pattern.

In step 760, a lithographic compensation process is performed on the first intermediate layout pattern and the second modified intermediate layout pattern so as to generate a compensated mask pattern.

In FIG. 8, a flow diagram is shown with individual process steps capable of correcting etch and lithographic processes for a photo mask.

In step 810, an etch proximity correction on a layout design pattern is performed.

In step 820, a first and a second intermediate layout pattern each being based on the etch proximity corrected layout design pattern are provided.

In step 830, an optical proximity correction on the first intermediate layout pattern is performed so as to generate a modified first intermediate layout pattern.

In step 840, scatterbar generation on the second intermediate layout pattern is performed so as to generate a modified second intermediate layout pattern including scatterbars.

In step 850, generating a mask layout pattern being based on the first and the second modified intermediate layout pattern is performed.

It should be noted that the scatterbar generating step can be repeated iteratively by using the output of step 850 as a third intermediate layout pattern, which is used as an input for iteratively performed steps scatterbar generation before the final mask layout is generated.

Having described embodiments of the invention, it is noted that modifications and variations can be made by persons skilled in the art in light of the above teachings. It is therefore to be understood that changes may be made in the particular embodiments of the invention disclosed which are within the scope and spirit of the invention as defined by the appended claims.

Having thus described the invention with the details and the particularity required by the patent laws, what is claimed and desired to be protected by Letters Patent is set forth in the appended claims.

What is claimed is:

1. A method of correcting etch and lithographic processes for a photo mask, the method comprising:
providing a layout pattern;
performing etch process compensation on the layout pattern so as to generate an etch compensated layout pattern;
generating a first intermediate layout pattern from the etch compensated layout pattern;
generating a second intermediate layout pattern from the etch compensated layout pattern;
modifying the second intermediate layout pattern by performing a scatterbar generating process on the second intermediate layout pattern; and
performing a lithographic compensation process on the first intermediate layout pattern and the second modified intermediate layout pattern so as to generate a compensated mask pattern.

2. The method according to claim 1, wherein the first intermediate layout pattern comprises pattern segments that are arranged on a first grid, the first grid being smaller than a production grid of a photo mask.

3. The method according to claim 2, wherein the pattern segments of the first intermediate layout pattern are arranged as short fragments.

4. The method according to claim 1, wherein the second intermediate layout pattern is arranged on a second grid, the second grid being substantially equal to a production grid of a photo mask.

5. The method according to claim 4, further comprising subjecting the second intermediate layout pattern to a smoothing procedure.

6. The method according to claim 5, wherein the smoothing procedure results in reducing gaps within the second intermediate layout pattern.

7. The method according to claim 5, wherein the smoothing procedure results in reducing recesses within the second intermediate layout pattern.

8. A method of correcting etch and lithographic processes on a photo mask, the method comprising:
performing an etch proximity correction on a layout design pattern;
providing a first and a second intermediate layout pattern that are each based on the etch proximity corrected layout design pattern;
performing an optical proximity correction on the first intermediate layout pattern so as to generate a modified first intermediate layout pattern;
performing scatterbar generation on the second intermediate layout pattern so as to generate a modified second intermediate layout pattern including scatterbars; and
generating a mask layout pattern being based on the first and the second modified intermediate layout patterns.

9. The method according to claim 8, wherein the etch proximity correction is applied to at least one pattern segment of a structure within the layout design pattern so as to compensate for etch effects of surrounding structures.

10. The method according to claim 8, wherein the pattern segments of the first intermediate layout pattern are arranged as short fragments irrespective of a production grid of a mask writer usable for production of a photo mask.

11. The method according to claim 8, further comprising subjecting pattern segments within the second intermediate layout pattern to a smoothing procedure so as to result in less fragmented scattering bars during the step of performing scatterbar generation on the second intermediate layout pattern.

12. The method according to claim 11, wherein the smoothing procedure results in reducing recesses or gaps within the second intermediate layout pattern.

13. The method according to claim 8, wherein performing scatterbar generation on the second intermediate layout pattern comprises performing scatterbar generation so as to increase a process window during a lithographic projection using the photo mask.

14. A system of correcting etch and lithographic processes for a photo mask, the system comprising:
an input interface, the input interface being capable of receiving a layout design pattern;
a processing unit, the processing unit being capable of storing the layout design pattern; performing an etch proximity correction on a layout design pattern; providing a first and a second intermediate layout pattern based on the etch proximity corrected layout design pattern; performing an optical proximity correction on the first intermediate layout pattern so as to generate a modified first intermediate layout pattern; performing scatterbar generation on the second intermediate layout pattern so as to generate a modified second intermediate layout pattern including scatterbars; and generating a mask layout pattern being based on the first and the second modified intermediate layout pattern; and
an output interface, the output interface being capable of transmitting the mask layout pattern to a mask writer or to an intermediate file.

15. A computer readable medium, the computer readable medium including instructions capable of performing the following steps on a computer:
reading input data including a layout design pattern;
performing an etch proximity correction on a layout design pattern;
providing a first and a second intermediate layout pattern each being based on the etch proximity corrected layout design pattern;
performing an optical proximity correction on the first intermediate layout pattern so as to generate a modified first intermediate layout pattern;
performing scatterbar generation on the second intermediate layout pattern so as to generate a modified second intermediate layout pattern including scatterbars;
generating a mask layout pattern being based on the first and the second modified intermediate layout pattern; and
transmitting the mask layout pattern to a mask writer or to an intermediate file.

16. The computer readable medium according to claim 15, wherein the etch proximity correction is applied to at least one pattern segment of a structure within the layout design pattern so as to compensate for etch effects of surrounding structures.

17. The computer readable medium according to claim 15, wherein pattern segments of the first intermediate layout pattern are arranged as short fragments irrespective of a production grid of a mask writer usable for production of a photo mask.

18. The computer readable medium according to claim 15, wherein pattern segments within the second intermediate layout pattern are subjected to a smoothing procedure so as to result in less fragmented scattering bars during the step of performing scatterbar generation on the second intermediate layout pattern.

19. The computer readable medium according to claim 18, wherein the smoothing procedure results in reducing recesses or gaps within the second intermediate layout pattern.

20. The computer readable medium according to claim 15, wherein the step of performing scatterbar generation on the second intermediate layout pattern is performed so as to increase a process window during a lithographic projection using a photo mask.

21. The computer readable medium according to claim 15, which is used to control a process sequence on a computer aided design program capable of performing the method steps in response to a signal command.

22. A method of correcting etch and lithographic processes on a photo mask, the method comprising:
reading input data including a layout design pattern;
performing an etch proximity correction on a layout design pattern;
providing a first and a second intermediate layout pattern, each being based on the etch proximity corrected layout design pattern;
performing an optical proximity correction on the first intermediate layout pattern so as to generate a modified first intermediate layout pattern;
performing scatterbar generation on the second intermediate layout pattern so as to generate a modified second intermediate layout pattern including scatterbars;
generating a third intermediate layout pattern being based on the first and the second modified intermediate layout pattern;
iteratively performing scatterbar generation by using the third intermediate layout pattern as input during the step of performing scatterbar generation; and
generating a mask layout pattern and transmitting the mask layout pattern to a mask writer or to an intermediate file.
